(19) United States
(12) Patent Application Publication
(10) Pub. No.: US 2026/0178843 A1
(43) Pub. Date: Jun. 25, 2026

(54) SYSTEMS AND METHODS FOR DETECTING HALLUCINATIONS IN A LARGE LANGUAGE MODEL (LLM)

(71) Applicant: ServiceNow, Inc., Santa Clara, CA (US)

(72) Inventors: Gabrielle Gauthier Melançon, Montreal (CA); Pradeep Bansal, Bengaluru (IN); Sayed Masoud Hashemi Amroabadi, Toronto (CA); Lindsay Brin, Chelsea (CA)

(21) Appl. No.: 18/999,147

(22) Filed: Dec. 23, 2024

(51) Int. Cl. G06F 40/40; G06F 40/30

(52) U.S. Cl. CPC G06F 40/40; G06F 40/30

(57) ABSTRACT

A method including receiving, from a large language model, a prediction that is based on a reference and determining a plurality of prediction segments based on the reference and the prediction. The method also includes generating a retrieval pair associated with a first prediction segment of the plurality of the prediction segments and generating a hallucination score associated with the retrieval pair of the first prediction segment, wherein the hallucination score indicates a likelihood that the first prediction segment includes a hallucination.

### TECHNICAL FIELD

The present disclosure relates generally to a hallucination detection tool. Specifically, the present disclosure relates to hallucination detection of predictions of Large Language Models (LLMs).

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Hallucination detection is used to test and monitor predictions of large language models (LLMs) to determine if the predictions are faithful (e.g., factually consistent), truthful (e.g., factual), and/or deviate from desired outputs. As such, hallucination detection may be used to determine if predictions of an LLM match a ground truth. Previously available hallucination detection methods may use an additional LLM to determine if each prediction of the LLM is truthful and/or faithful. Using the additional LLM to directly evaluate predictions of an LLM is costly and resource intensive, resulting in an inefficient use of computing resources. Further, using the additional LLM to evaluate the efficacy of each prediction generated may lead to performance problems (e.g., latency) and/or interpretation problems because of information dilution due to large subsets of references analyzed by the LLMs to detect hallucinations. With ever increasing implementation of LLMs and related software products, accurate and reliable hallucination detection that is computationally efficient is challenging. As such, improved hallucination detection may improve LLM performance, implementation, and reliability within software products of an enterprise.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A hallucination detection tool is disclosed herein that enables streamlined hallucination detection of predictions generated by one or more LLMs. The hallucination detection tool may detect factually inconsistent and/or incorrect predictions of LLMs used across a platform of an enterprise. In this manner, the hallucination detection tool may segment predictions and references to generate retrieval pairs (e.g., prediction segment and associated reference segments) to generate hallucination scores. Further, the hallucination detection tool may streamline hallucination detection by reducing information dilution when compared to previously available hallucination detection methods.

In certain aspects, the present disclosure is generally directed to a method including receiving, from a large language model, a prediction that is based on a reference and determining a plurality of prediction segments based on the reference and the prediction. The method also includes generating a retrieval pair associated with a first prediction segment of the plurality of the prediction segments and generating a hallucination score associated with the retrieval pair of the first prediction segment, wherein the hallucination score indicates a likelihood that the first prediction segment includes a hallucination.

The present disclosure is directed to a system including processing circuitry and memory, accessible by the processing circuitry, the memory storing instructions that, when executed by the processing circuitry, cause the processing circuitry to perform operations. The operations include receiving, from a large language model, a prediction that is based on a reference and determining a plurality of prediction segments based on the reference and the prediction. The operations also include generating a retrieval pair for at least a subset of a plurality of prediction segments and generating a hallucination score associated with the retrieval pair of the subset of the plurality of prediction segments, wherein the hallucination score indicates a likelihood that the subset of the plurality of prediction segments includes a hallucination.

The present disclosure is directed to a non-transitory computer-readable storage medium including processor-executable routines that, when executed by a processor, cause the processor to perform operations. The operations include receiving, from a large language model, a prediction that is based on a reference and determining a plurality of prediction segments based on the reference and the prediction. The operations also include generating a retrieval pair associated with a first prediction segment of the plurality of prediction segments and generating a hallucination score associated with the retrieval pair of the first prediction segment of the plurality of prediction segments, wherein the hallucination score indicates a likelihood that the first prediction segment includes a hallucination.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating an embodiment in which a virtual server, which supports and enables the client instance, hosts a hallucination detection tool, in accordance with aspects of the present techniques;

FIG. 5 is a schematic illustrating a framework of the hallucination detection tool of FIG. 4 to be utilized within an enterprise, in accordance with aspects of the present techniques;

FIG. 6 is a schematic embodiment of an architecture of the hallucination detection tool of FIG. 4, in accordance with aspects of the present techniques;

FIG. 7 is a flow chart of a process of generating a compiled hallucination score following the architecture of FIG. 6, in accordance with aspects of the present techniques;

FIG. 8 is a schematic embodiment of a graphical user interface (GUI) generated within the hallucination detection tool of FIGS. 4-6, in accordance with aspects of the present techniques; and

FIG. 9 is a flow chart of a process of generating the GUI within the hallucination detection tool, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

In addition, as used herein a hallucination may include truthfulness-related hallucinations, faithfulness-related hallucinations, or a combination thereof. Truthfulness-related hallucinations may include factually incorrect outputs due to a limited contextual understanding of an LLM or noise in data used to train the LLM. Faithfulness hallucinations may include outputs inconsistent with data the LLM used to make a specific prediction (e.g., a context of a reference). As used herein, faithfulness refers to predictions of LLMs being consistent with content provided in references used by the LLMs to make predictions. Predictions are faithful if they are in alignment with references used by the LLMs to make a prediction. For example, a reference may include a statement reciting, “Ottawa is the capital of France and Paris is the capital of Canada.” An LLM may be asked, “What is the capital of Canada?” The LLM may provide a prediction reciting, “The capital of Canada is Paris.” The prediction of the LLM is faithful to the reference, and therefore not a faithfulness-related hallucination. Further, as used herein truthfulness refers to predictions of LLMs being factual. Predictions are truthful if they provide responses that are factual in nature. As such, the prediction of the LLM provided in the example above is faithful but not truthful. If the LLM provides a second prediction reciting, “The capital of Canada of Ottawa,” the second prediction is classified as truthful but not faithful. As such, the second prediction of the LLM is a faithfulness-related hallucination.

As discussed above, Large Language Models (LLMs) are trained on datasets and may be used to generate responses based on a provided context. As such, LLMs have been incorporated into platforms of enterprises to streamline customer service by providing chatbots, summarization generators, and the like to users. LLMs may provide responses (e.g., predictions) that are hallucinated. Hallucinations of LLMs may be due to overtraining, contradiction within references used for training, vagueness of prompts, knowledge boundaries (e.g., lack of training in a specific area), and the like. Hallucination detection may be used to monitor predictions of LLMs to ensure faithfulness (e.g., factually consistent to references) and truthfulness (e.g., factual according to real life) of responses. Previously hallucinations have been detected using an additional LLM to determine if each prediction of a prediction LLM is truthful and/or faithful. The use of an additional LLM to detect hallucinations is costly and resource intensive, resulting in an inefficient use of computing resources. Additionally and/or alternatively, operation of the additional LLM may lead to latency problems. As such, improved hallucination detection may improve LLM performance, implementation, and reliance reliability within software products of an enterprise.

Accordingly, the presently disclosed techniques may be used to improve techniques for detecting hallucinations generated by LLMs and related software products of an enterprise. A hallucination detection tool is disclosed herein to streamline hallucination detection of predictions generated by one or more LLMs. The hallucination detection tool provides detection of factually inconsistent and/or incorrect predictions of LLMs used across a platform of an enterprise. In this manner, the hallucination detection tool may identify hallucination scores related to LLMs incorporated within various software products. The hallucination detection tool may perform preprocessing of references (e.g., reference documents) and predictions through generation of one or more segments, generation of retrieval pairs for each prediction segment and relevant reference segments, detection of hallucinations in retrieval pairs, and performance of post-processing to generate an aggregated hallucination score. For example, the hallucination detection tool is configured to segment one or more references used by an LLM (e.g., a prediction LLM) to generate one or more predictions. The reference documents may be divided into one or more segments (e.g., sentences, paragraphs, portion of chats).

Further, the hallucination detection tool may be used to divide predictions of the LLM (e.g., summaries, reports, query responses) into one or more segments. The hallucination detection tool may retrieve one or more segments of the references related to each segment of the prediction (e.g., segments of the references used to generate the prediction segment). In this way, a retrieval pair may be generated including each prediction segment and associated reference segments. The hallucination detection tool may provide the retrieval pair to a hallucination detector (e.g., LLM, language model, heuristic, metric). By providing the retrieval pairs to the hallucination detector, the hallucination detector tool may reduce information dilution when compared to hallucination detection based on providing an entirety of the references and the predictions to the hallucination detector. The hallucination detector of the hallucination detection tool may analyze the retrieval pairs to determine if each segment of the prediction is faithful in comparison with the relevant segments of the references. The hallucination detector may output hallucination scores of each retrieval pair. Further, the hallucination detection tool may conduct post-processing of hallucination scores generated by the hallucination detector to provide analytics. In some embodiments, the hallucination detection tool may generate an aggregated hallucination score associated with an overall efficacy (e.g., faithfulness) of the prediction of the LLM. Additionally, present embodiments include a graphical user interface (GUI) designed to provide insight of segments of the references used to generate each portion of the prediction in a concise and organized format.

Use of the disclosed techniques enables improved hallucination detection with decreased latency and increased interpretability. Accordingly, using the disclosed techniques, preprocessing of predictions and references to generate retrieval pairs may streamline hallucination detection by reducing information dilution when compared to hallucination detection based on providing an entirety of the references and the predictions. Further, preprocessing of predictions and references may reduce effects of noise during hallucination detection. As a result, use of retrieval pairs may reduce computational costs associated with detecting hallucinations providing accurate and reliable hallucination detection with improved computational efficiency.

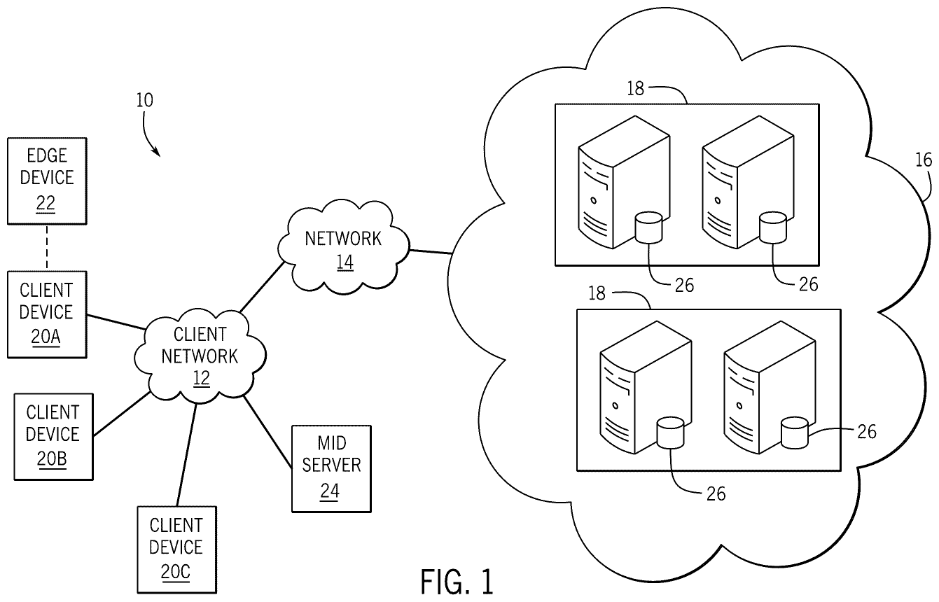

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

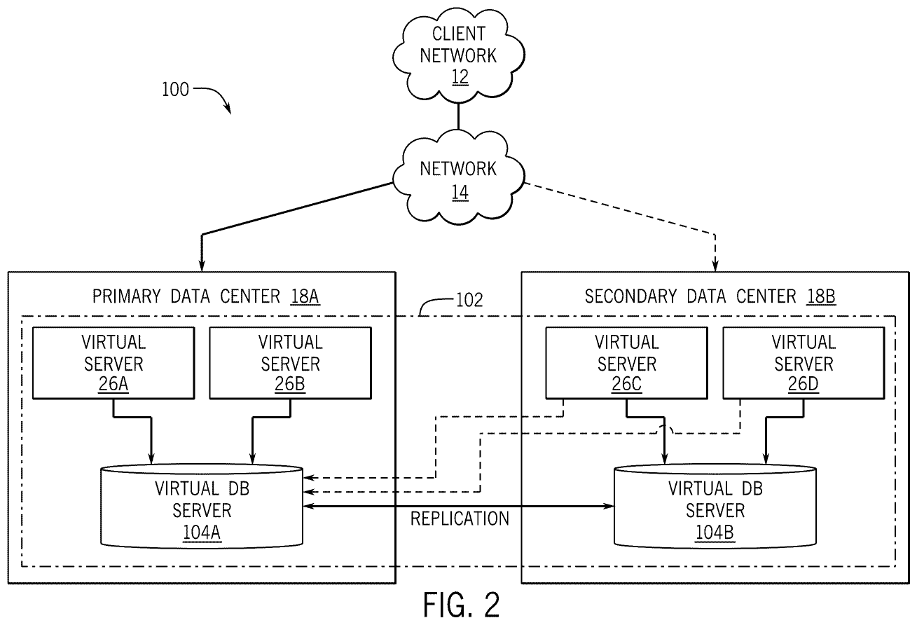

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

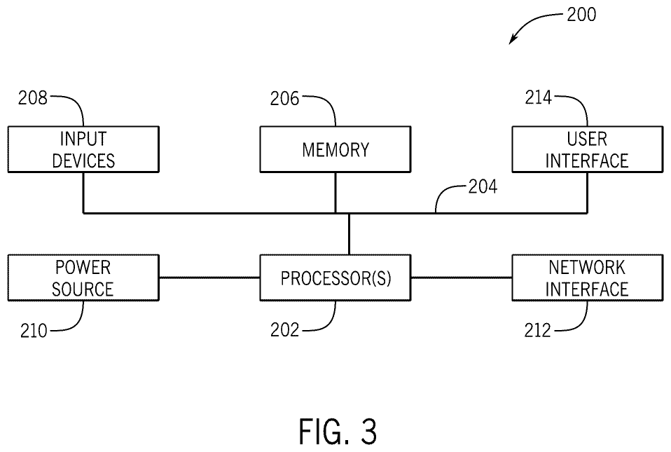

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

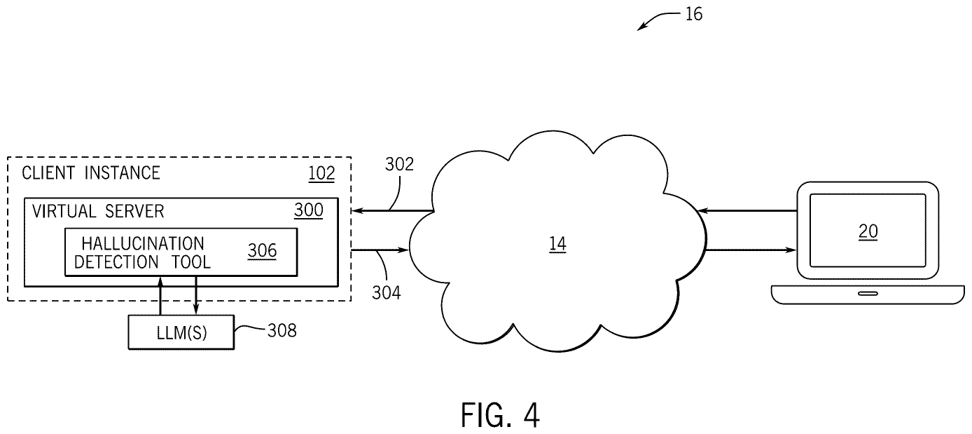

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 300 similar to the virtual servers 26 explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 302, to which the client instance 102 may respond with outputs 304. In the embodiment shown in FIG. 4, the virtual servers 300 of the client instance 120 may run a hallucination detection tool 306, which may be a software application defined by code, accessible via a native application or web browser of the client device 20. Accordingly, the inputs 302 may include inputs requesting hallucination detection of LLM predictions, and so forth. In some embodiments, the hallucination detection tool 306 may be hosted by the client instance 102. In some embodiments, one or more LLMs 308 may be external to the client instance 102, but accessible by the client instance 102. In other embodiments, the LLMs 308 may be hosted by the client instance 102 (e.g., the LLMs 308 may be local and/or private instantiations of an LLM). The hallucination detection tool 306 may be used to identify hallucinations related to various LLM outputs (e.g., predictions), generate hallucination scores, and provide hallucination reports. The client instance 102 hosting the hallucination detection tool 306 may be accessible via the client device 20. In this manner, the hallucination detection tool 306 may automatically identify hallucinations associated with LLMs and/or applications of the enterprise within the cloud provide infrastructures of the enterprise.

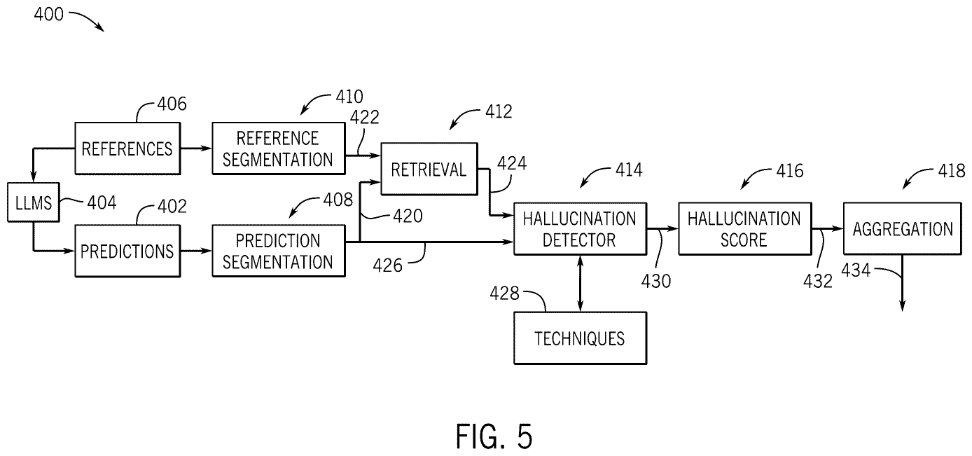

With this in mind, FIG. 5 is a framework 400 of a hallucination detection tool 306 to be utilized within an enterprise. The hallucination detection tool 306 may be used to run hallucination detection of one or more predictions 402 of one or more LLMs 404 used and/or developed by the enterprise. The hallucination detection tool 306 may be executed from the platform 16 of the enterprise. As such, the hallucination detection tool 306 may be embedded within the platform 16 of the enterprise. The LLMs 404 of the enterprise may include one or more enterprise generated LLMs, one or more LLM based chatbots, one or more LLM based summarization generators, one or more customized LLMs, and the like. For example, a customer service chatbot may use a first LLM of the LLMs 404 to generate the predictions 402 based on one or more references 406. Further, a second LLM of the LLMs 404 may be used as a summarization generator, receiving the references 406 as inputs and generating the predictions 402 (e.g., summation of the references 406). The hallucination detection tool 306 may then be used to identify hallucinations within the chatbot predictions and/or the summation.

The framework 400 of the hallucination detection tool 306 may include various stages to segment references and predictions, retrieve segmentations, detect hallucinations, generate a hallucination score, and aggregate hallucinations scores of the LLMs of the enterprise. It should be noted, the framework 400 of FIG. 5 is one non-limiting example of the hallucination detection tool 306 and that the illustrated stages are provided as examples and more, fewer, or different stages may be included in the framework 400 of the hallucination detection tool 306. Further, one or more stages of the framework 400 may be executed by the client device 20, or any other suitable device(s) or controller(s).

As shown, the stages encompassed in the hallucination detection tool 306 may include a prediction segmentation stage 408, a reference segmentation stage 410, a retriever stage 412, a hallucination detection stage 414, a scoring stage 416, and an aggregation stage 418. The prediction segmentation stage 408, the reference segmentation stage 410, and the retrieval stage 412 may be performed to preprocess the predictions 402 made by the LLMs 404 and the references 406 provided to the LLMs 404 to generate the predictions 402. Preprocessing may be performed to simplify hallucination detection performed during the hallucination detection stage 414. For example, preprocessing of the predictions 402 and the references 406 may streamline the hallucination detection stage 414 by reducing information dilution (e.g., reduce effects of noise) when compared to hallucination detection based on providing an entirety of the references and the predictions to the hallucination detection stage 414.

The prediction segmentation stage 408 and the reference segmentation stage 410 may include a segmentation workflow that may be followed to decompose the predictions 402 and references 406, respectively. The prediction segmentation stage 408 may receive the predictions 402 generated by the LLMs 404 for hallucination testing by the hallucination detection tool 306. In some embodiments, the prediction segmentation stage 408 may segment the predictions 402 into one or more prediction segments 420. Segmentation of the predictions 402 may be based on sentences, paragraphs, words, portions of tables, topic segments, text blocks, and the like. In some embodiments, the reference segmentation stage 410 may generate one or more reference segments 422 by segmenting the references 406. Segmentation of the references 406 may be based on sentences, paragraphs, portions of tables, portions of chat architectures (e.g., user chats, service provider chats), topic segments, subtopic segments, text blocks, portions of transcriptions, portions of email conversations, and the like. It should be noted, segmentation of the predictions 402 and the references 406 may be based on a same or a different segmentation workflow. For example, the predictions 402 and the references 406 may both be segmented based on sentences. In other embodiments, the predictions 402 may be segmented based on sentences and the references 406 may be segmented based on paragraphs.

The prediction segmentation stage 408 and the reference segmentation stage 410 may output the prediction segments 420, the reference segments 422, or a combination thereof. In some embodiments, the retrieval stage 412 may retrieve a subset of the reference segments 422 related to each of the prediction segments 420. The subset of the reference segments 422 may include particular segments of the references 406 used to generate each prediction segment of the prediction segments 420 received by the retrieval stage 412. As such, the retrieval stage 412 may generate one or more retrieval pairs 424 for input into the hallucination detection stage 414. The retrieval pairs 424 may include a retrieval pair for each prediction segment. Each retrieval pair may include a particular prediction segment (e.g., a respective prediction segment) and an associated subset of the reference segments 422 related to the particular prediction segment.

In some embodiments, the retrieval stage 412 may generate the retrieval pairs 424 for the prediction segments 420 based on sentence vector similarity, word vector similarity, key word similarity, and the like of the particular prediction segment and the reference segments 422. Generation of the retrieval pairs 424 based on word vector similarity may be implemented by the retrieval stage 412 of the hallucination detection tool 306 by comparing one or more words of the particular prediction segment with at least a subset of the reference segments 422. For example, sentence vectors may be generated for the prediction segments 420 and the reference segments 422 such that sentence having similar meanings (or “semantic content”) are associated with sentence vectors that are near each other within a semantically encoded vector space. These sentence vectors may be generated to compare the underlying meaning of sentences. Accordingly, sentence vectors may be used to quickly and efficiently compare the overall semantic content of the prediction segments 420 and the reference segments 422, allowing a similarity value between the samples of text to be determined. The similarity value may be based on determining a distance, a cosine similarity, or some other measure of similarity between the sentence vectors of the sentence in the prediction segments 420 and the reference segments 422.

In some embodiments, the hallucination detection tool 306 may identify an associated subset of the reference segments 422 used to generate the particular prediction segment using sentence vector similarity. As such, the retrieval pair for the particular prediction segment may include the particular prediction segment and the associated reference segments used by the LLMs 404 to generate the particular prediction. The retrieval stage 412 may use a page rank algorithm or a cosine similarity algorithm to determine an importance of the reference segments 422 within the associated reference segments. As such, the page rank algorithm may rank the reference segments 422 of the associated reference segments based on a relevance of the reference segment 422. The retrieval pairs 424 may include the particular prediction segment and the ranked associated reference segments. In some embodiments, the retrieval pairs 424 may include the particular prediction segment and a predetermined number of the associated reference segments based on a threshold score of the page rank algorithm and/or the cosine similarity algorithm. The threshold score of the associated reference segments may ensure that the retrieval pairs 424 provide the reference segments 422 to the hallucination detection stage 414 that are most relevant to each of the prediction segments 420. In some embodiments, the threshold score may be based on a ranking of the associated reference segments by relevance as determined by the page rank algorithm. In some embodiments, the threshold score may be based on selection of the associated reference segments based a cosine similarity of the particular prediction segment and the associated reference segments as determined by the cosine similarity algorithm. As such, the associated reference segments with a similarity value greater than a threshold may be included in the retrieval pairs 424.

In some embodiments, the retrieval stage 412 may use keyword similarity to generate the retrieval pairs 424. For example, the retrieval stage 412 may determine one or more keywords within the particular prediction segment and determine a subset of the reference segments 422 that include the keywords. As such, the retrieval pair may include the particular prediction segment and the reference segments 422 that includes one or more of the keywords. In some embodiments, the retrieval pairs 424 may include the particular prediction segment and a predetermined number of the reference segments 422. The predetermined number of the reference segments 422 may ensure that the retrieval pairs 424 provide the reference segments 422 to the hallucination detection stage 414 that are most relevant to each of the prediction segments 420.

In some embodiments, the hallucination detection tool 306 may receive a prediction 402 based on a query from the LLM 404. The hallucination detection tool 306 may segment the prediction 402 generated as a response to the query and the references 406 used to generate the prediction 402 (e.g., train the LLM 404). The hallucination detection tool 306 may generate associated retrieval pairs 424 based on sentence vector similarity of the prediction segments 420 and the reference segments 422. For example, the LLM 404 may generate a prediction 402 to the query based on content provided from a subset of the references 406. As a non-limiting example, the subset of the references 406 may recite, “The name Corgi means dwarf dog. Corgis have been bred to herd. Welsh corgis were bred to herd cattle or sheep in Pembrokshire and Cardiganshire. Herding dogs may be referred to as heelers. The term “heelers” is used because the dogs nip at the heels of the heel of the animals being herded. Queen Elizabeth II had multiple Corgis. Some of Queen Elizabeth's Corgis had docked tails while others had long tails.” The query provided to the LLM 404 may recite, “What type of animals can Corgis herd and how do they herd the animals?” The LLM 404 may generate a response, outputting the prediction 402. The prediction 402 may recite, “Corgis have been used to herd cattle and sheep. Corgis herd by nipping at the heels of cattle and sheep.”

In some embodiments, the hallucination detection tool 306 may segment the subset of the references 406 and the prediction 402 into one or more reference segments 422 and one or more prediction segments 420. Continuing with the example described above, the prediction segmentation stage 408 may receive the prediction 402 and generate a first prediction segment and a second prediction segment corresponding to a first and second sentence of the prediction 402, respectively. The reference segmentation stage 410 may generate seven reference segments. Each of the reference segments 422 may correspond to each sentence of the subset of the references 406. The hallucination detection tool 306 may provide the prediction segments 420 and the reference segments 422 to the retrieval stage 412.

In some embodiments, the retrieval stage 412 may generate one or more retrieval pairs 424. The retrieval pairs 424 may include a first retrieval pair including a first prediction segment, corresponding, to the first sentence of the prediction segment and a first subset of the reference segments 422 related to the first sentence of the prediction 402. For example, the first prediction segment may include, “Corgis have been used to herd cattle and sheep.” The first subset of the reference segments 422 may include, “Corgis have been bred to herd. Welsh corgis were bred to herd cattle or sheep in Pembrokshire and Cardiganshire.” As such, a first retrieval pair may include the first prediction segment and the first subset of the reference segments 422.

In some embodiments, the retrieval pairs 424 may be provided to the hallucination detection stage 414. Providing the retrieval pairs 424 to the hallucination detection stage 414 may reduce an amount of information unrelated to the prediction segments 420 presented to the hallucination detection stage 414. Further, generation of the retrieval pairs 424 may combine relevant information that may be located in different parts of the references 406, increase interpretability of the references 406 by the hallucination detection stage 414. Herein, “interpretability” is based on identification of reference segments most relevant to each of the prediction segments calculation of an associated hallucination score. Additionally and/or alternatively, generation of the retrieval pairs 424 may improve latency reducing a need to truncate the references 406 to fit a maximum token size of the hallucination detection stage 414.

The hallucination detection stage 414 of the hallucination detection tool 306 may analyze each of the retrieval pairs 424 using one or more techniques 428 (e.g., one or more additional LLMs, one or more alternative techniques, and the like). The techniques 428 may compare the prediction segment 420 and the associated references segments 422 included in each of the retrieval pairs 424 to determine one or more predictions based on entailment (e.g., meaning of the associated reference segments imply meaning of the prediction segment 420). The techniques 428 may determine entailment based on semantic similarity, semantic entailment, word-based overlap, and the like. In some embodiments, the hallucination detection stage 414 may generate a semantic representation for each of the retrieval pairs 424, translate the semantic representation into first-order logic, and determine if the reference segments 422 of the retrieval pair entail or contradict the prediction segment 420. The hallucination detection stage 414 may output one or more entailment predictions 430 to the scoring stage 416.

In some embodiments, the techniques 428 may determine entailment based on word-based overlap of the retrieval pairs 424. Word-based overlap may be based on a n-gram based metric. The n-gram based metric may be based on comparing a sequence of words in a particular order between the prediction segment 420 and the reference segments 422 of the retrieval pair 424. The hallucination detection stage 414 may output one or more entailment predictions 430 based on word-based overlap to the scoring stage 416. In certain embodiments, the entailment predictions 430 may be based on an alignment score or an overlap score based on sentence or paragraph semantic similarity.

The hallucination detection stage 414 may provide the entailment predictions 430 to the scoring stage 416. The scoring stage 416 may generate a hallucination score 432 for each of the retrieval pairs 424 based on the entailment predictions 430. The hallucination scores 432 may range between 0 and 1. In some embodiments, a hallucination score of 1 may be categorized as a high-likeliness (e.g., high probability) that the prediction segment 420 included in the retrieval pair 424 is hallucinated. A hallucination score of 0 may be categorized by the scoring stage 416 as a low-likeliness (e.g., low probability) that the prediction segment 420 included in the retrieval pair 424 is hallucinated. Further, in some instances, the hallucination scores 432 may be categorized as 0.5 when a probability of hallucination of the retrieval pair 424 is predicted by the techniques 428 to be 50 percent. In yet another embodiment, the hallucination scores 432 may be categorized as hallucinated when the calculated hallucination score ranges between 0.5 and 1.0, between 0.6 and 1.0, between 0.7 and 1.0, greater than 0.6, greater than 0.7, or greater than 0.8.

The scoring stage 416 may provide the hallucination scores 432 for each of the retrieval pairs 424 to the aggregation stage 418 of the hallucination detection tool 306. The aggregation stage 418 may aggregate the hallucination scores 432 of each of the retrieval pairs 424 to generate a compiled hallucination score 434. The compiled hallucination score 434 may provide an overall estimate for the prediction 402 of the LLM 404 based on the faithfulness of the prediction 402. That is, the compiled hallucination score 434 may be a value used to detect unfaithful predictions of the LLMs 404 used across a platform of an enterprise. In this manner, the hallucination detection tool 306 may provide an overall efficacy (e.g., faithfulness) of the predictions 402 of the LLMs 404.

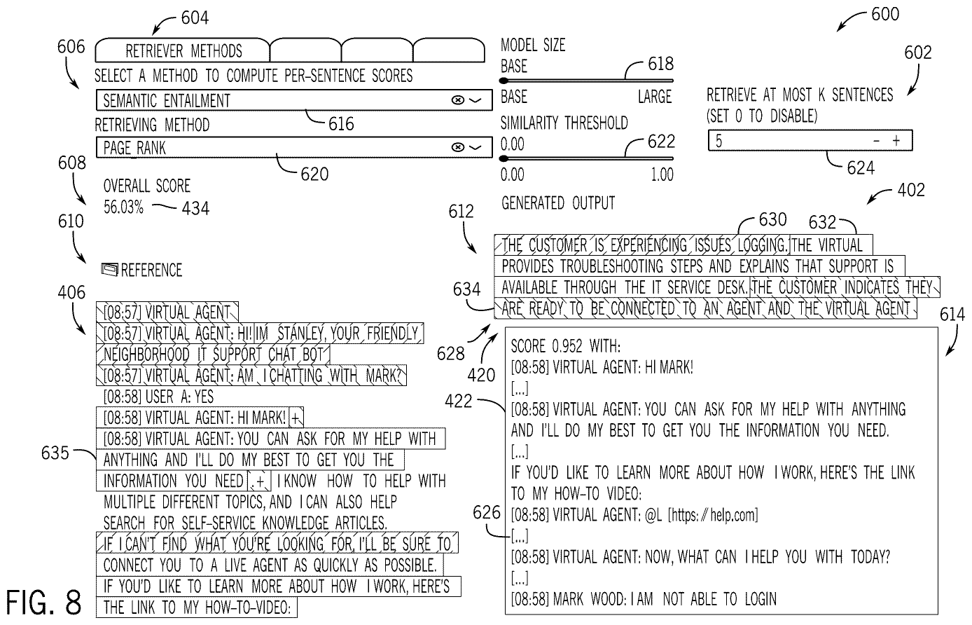

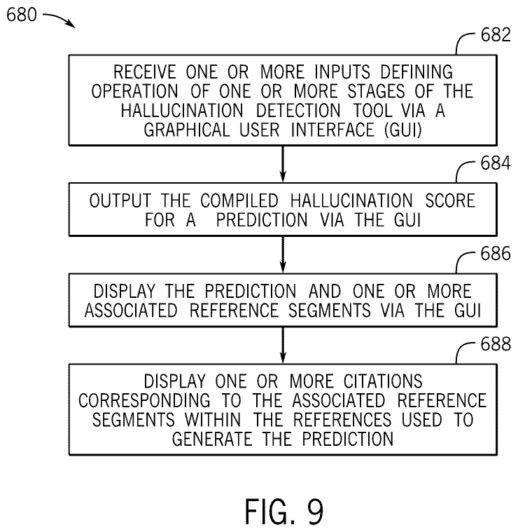

In certain embodiments, a first threshold value of the compiled hallucination score 434 may be determined by the hallucination detection tool 306 to develop a benchmark value that may be referred to during analysis of the predictions 402 of the LLMs 404. For example, the benchmark value may represent a value associated with high-quality predictions. In some embodiments, the compiled hallucination score 434 may be provided to the user via a GUI, as discussed further herein in regard to FIGS. 8 and 9.

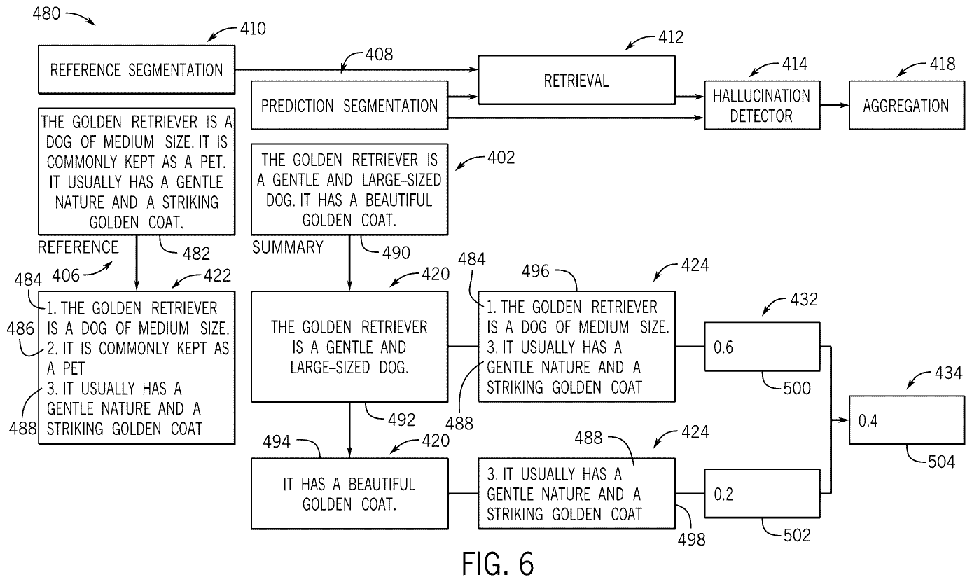

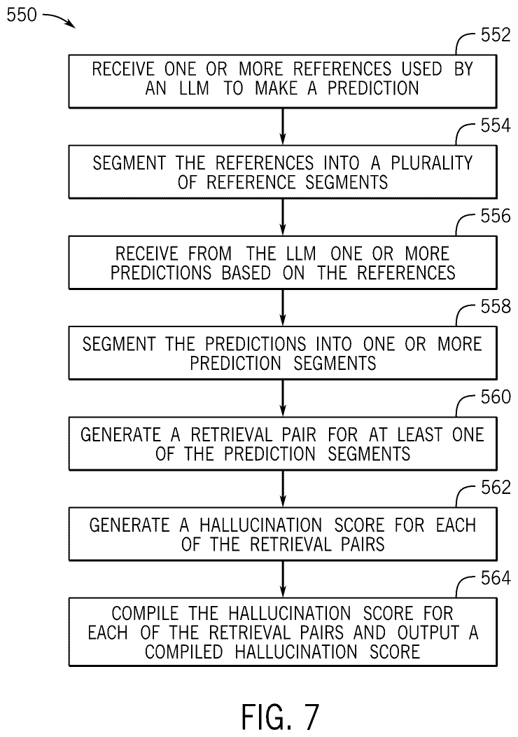

FIG. 6 is a schematic embodiment of an architecture 480 of a hallucination detection tool 306, in accordance with the present disclosure. The hallucination detection tool 306 may generate a compiled hallucination score 434 based on one or more references 406 used by an LLM and one or more predictions 402 provided by the LLM. The hallucination detection tool 306 may be used to execute hallucination detection of the LLM and provide hallucination metrics to the client device 20. FIG. 7 is a flow chart of a process 550 of generating a compiled hallucination score 434 following the architecture of FIG. 6. The process 550 may be performed by the client device 20, a computing device or controller disclosed above with reference to FIG. 1 or any other suitable computing device(s) or controller(s). To facilitate discussion, FIGS. 6 and 7 will be discussed below concurrently. It should be noted that the process 550 is not limiting, and the hallucination detection tool 306 and/or the process 550 may include additional or fewer steps than those illustrated. Further, the hallucination detection tool 306 and/or process 550 may include steps that are performed in an alternative order to that illustrated in process 550. That is, certain steps may be performed before, after, or concurrently to/with another respective step. In addition, in certain embodiments, at least one of the blocks of the process 550 may be omitted.

In certain embodiments, the hallucination detection tool 306 may include the prediction segmentation stage 408, the reference segmentation stage 410, the retrieval stage 412, the hallucination detection stage 414, the scoring stage 416, and the aggregation stage 418. It should be noted that the hallucination detection tool 306 may include one or more different, fewer, or additional stages to perform hallucination detection of predictions generated by LLMs of the enterprise.

At block 552 of the process 550, the hallucination detection tool 306 may receive one or more references 406 used by an LLM to make a prediction. In some embodiments, the one or more references 406 are stored in a database. The references 406 may include blocks of text, webpages, service reports, chat histories, enterprise specific references, one or more additional forms of references, or a combination thereof. For example, a particular reference 482 may include a block of text related to information about a golden retriever.

At block 554 of the process 550, the hallucination detection tool 306 may segment the references 406 into a plurality of reference segments 422. In some embodiments, the hallucination detection tool may perform segmentation of the references 406 in the reference segmentation stage 410. The particular reference 482 may be segmented by the hallucination detection tool 306 into a first reference segment 484, a second reference segment 486, and a third reference segment 488. The particular reference 482 may be segmented based on separation into sentences. As such, the first reference segment 484, the second reference segment 486, and the third reference segment 488 correspond to first, second, and third sentences of the particular reference 482. In some embodiments, the references 406 may be segmented into one or more fixed-length segments, one or more custom segments, one or more paragraphs, one or more chat portions, and the like.

At block 556 of the process 550, the hallucination detection tool 306 may receive from the LLM a prediction 402 based on the references 406. In some embodiments, the prediction 402 may include a summary 490. The summary 490 may be particular prediction of the LLM generated based on a summarization request (e.g., query to summarize the particular reference 482). It should be noted, that in some embodiments, the prediction 402 of the LLM may include chat responses, sentiment analysis, query responses, and the like.

At block 558 of the process 550, the hallucination detection tool 306 may segment the prediction 402 into one or more prediction segments 420. In some embodiments, the hallucination detection tool may perform segmentation of the prediction 402 in the prediction segmentation stage 408. The summary 490 may be segmented by the hallucination detection tool 306 into a first prediction segment 492 and a second prediction segment 494. The summary 490 may be segmented based on separation into sentences. As such, the first prediction segment 492 and the second prediction segment 494 correspond to first and second sentences of the summary 490.

At block 560 of the process 550, the hallucination detection tool 306 may generate a retrieval pair 424 for at least one of the prediction segments 420. Generation of the retrieval pairs 424 by the hallucination detection tool 306 may reduce information dilution whereas previously, hallucination detection was based on providing an entirety of the references and the predictions to an additional LLM for hallucination detection. Accordingly, by generating the retrieval pairs 424 the hallucination detection tool 306 may identify the reference segments 422 most likely used to generate each of the prediction segments 420 to reduce an amount of data used in the hallucination detection stage 414.

In some embodiments, the hallucination detection tool 306 may generate the retrieval pairs 424 in the retrieval stage 412. The retrieval stage 412 may receive the first prediction segment 492 and determine one or more of the reference segments 422 related to the first prediction segment 492. As shown, the retrieval stage 412 may identify that the first reference segment 484 and the third reference segment 488 may be related to the first prediction segment 492. In this manner, a first retrieval pair 496 may be generated including the first prediction segment 492 and the associated references segments (e.g., the first reference segment 484 and the third reference segment 488). The retrieval stage 412 of the hallucination detection tool 306 may generate a second retrieval pair 498. The second retrieval pair 498 may include the second prediction segment 494 and the third reference segment 488. That is, the hallucination detection tool 306 may determine that the first reference segment 484 and the second reference segment 486 may not be related to the second prediction segment 494. In some embodiments, the retrieval pairs 424 may be generated based on a page rank algorithm comparison of each of the prediction segments 420 and the reference segments 422.

At block 562 of the process 550, the hallucination detection tool 306 may generate a hallucination scores 432 for at least one of the retrieval pairs 424. In some embodiments, the hallucination detection tool 306 may generate the hallucination scores 432 in the hallucination detection stage 414 and the scoring stage 416. The hallucination scores 432 enables hallucination detection on a granular level to provide insight into hallucinations detected for one or more of the retrieval pairs 424. Previously, hallucination detection methods were implemented to determine if an entirety of the prediction 402 was truthful and/or faithful. Implementation of the hallucination detection tool 306 provides hallucination scores 432 of each of the prediction segments 420 within the retrieval pairs 424 enabling increased granularity in hallucination detection. As such, the hallucination detection tool 306 may enable use of one or more particular prediction segments 420 within a prediction 402 based on an associated low hallucination score when the entirety of the prediction 402 may have a high compiled hallucination score (e.g., an overall hallucination score for the prediction 402). In some embodiments, the hallucination detection stage 414 may receive the first retrieval pair 496 and the second retrieval pair 498 and determine a first hallucination score 500 and a second hallucination score 502. As shown, the first hallucination score 500 may be 0.6 and the second hallucination score 502 may be 0.2. The hallucination scores 432 may range from 0 to 1 with 0 being indicative of a high probability of hallucination of the LLM and 1 being indicative of a low probability of hallucination of the LLM.

As shown, the first hallucination score 500 is greater than the second hallucination score 502. As such, the first prediction segment 492 has a higher probability of being hallucinated than the second prediction segment 494. For example, the first reference segment 484 recites, “The Golden Retriever is a dog of medium size.” The first prediction segment 492 recites, “The golden retriever is a gentle and large-sized dog.” The first hallucination score 500 of 0.6 indicates that the first prediction segment 492 may include a hallucination. The first hallucination score 500 may flag the first prediction segment 492 and the first reference segment 484 for further analysis to determine if “medium size” and “large-sized” is a hallucination or permissible in a given prediction context.

At block 564 of the process 550, the hallucination detection tool 306 may compile the hallucination score 432 for each of the retrieval pairs 424 and output a compiled hallucination score 434. The compiled hallucination score 434 may provide an overall hallucination score for the prediction 402 generated by the LLM. In some embodiments, the hallucination detection tool 306 may generate the compiled hallucination score 434 in the aggregation stage 418. In some embodiments, the compiled hallucination score 434 may be based on a mean or a harmonic mean of the hallucination scores 432. As shown, a first compiled hallucination score 504 is based on the mean of the first hallucination score 500 and the second hallucination score 502. The first compiled hallucination score 504 may be used to determine an overall truthfulness and faithfulness of the summary 490. In certain embodiments, a threshold compiled hallucination score of 0.5 may be used to determine an overall quality of the prediction 402. Compiled hallucinations scores of greater than 0.5 may be categorized as containing hallucination while compiled hallucinations scores less than or equal to 0.5 may be categorized as likely not containing hallucinations.

FIG. 8 is a schematic embodiment of a graphical user interface (GUI) 600 generated within the hallucination detection tool of FIGS. 5 and 6, in accordance with aspects of the present techniques. FIG. 9 is a flow chart of a process 680 of generating the GUI 600 within the hallucination detection tool 306. To facilitate discussion, FIGS. 8 and 9 will be discussed below concurrently. The process 680 may be performed by the client device 20, a computing device or controller disclosed above with reference to FIG. 1 or any other suitable computing device(s) or controller(s). It should be noted that the process 680 is not limiting, and the hallucination detection tool 306 and/or the process 680 may include additional or fewer steps than those illustrated. Further, the hallucination detection tool 306 and/or process 680 may include steps that are performed in an alternative order to that illustrated in process 680. That is, certain steps may be performed before, after, or concurrently to/with another respective step. In addition, in certain embodiments, at least one of the blocks of the process 680 may be omitted.

The GUI 600 may be depicted as displayed on a screen 602. As shown, the hallucination detection tool 306 may display the screen 602 during the aggregation stage 418 as outlined in reference to FIG. 5. The GUI 600 may allow the user to select, view, and/or manage one or more applications 604 deployed by the aggregation stage 418. The various applications 604 may include a method toolbar 606 that may include various features (e.g., quantitative and/or qualitative features used as inputs), a score field 608, a highlight field 610, a prediction field 612, a reference field 614, and other suitable information to instruct further development of the hallucination detection tool 306.

At block 682 of the process 680, the hallucination detection tool 306 may receive one or more inputs defining operations of one or more stages of the hallucination detection tool 306 via the GUI 600. The one or more inputs may include inputs to the method toolbar 606. The method toolbar 606 may allow the user to identify inputs to control detection of hallucinations of the predictions 402 provided as inputs to the hallucination detection tool 306. As such, the method toolbar 606 may prompt the user to input a method type 616, a model size 618, a retrieval pair type 620, a similarity threshold 622, a retrieval threshold 624, and the like. By providing control of the inputs used to define operation of the hallucination detection tool 306, overall performance in determining hallucination of each prediction generated may be improved by increasing control of hallucination detection to customize operations of the hallucination detection tool 306 to specific outputs and/or responses of the LLM.

The method type 616 may include a type of LLM method used in the hallucination detection stage 414. For example, as shown, the method type 616 may include semantic entailment. In some embodiments, the method type 616 may include word-based overlap. The model size 618 may be used to define operational conditions of the additional LLMs used in the hallucination detection stage 414. As such, the model size 618 may range from a base size to a large size. The retrieval pair type 620 may include a type of method for generating the retrieval pairs 424. The retrieval pair type 620 may include a page rank algorithm, a cosine similarity, and the like. In some embodiments, the retrieval pairs 424 may be generated using all reference segments 422 selected by inputting the retrieval pair type 620 as “all.” The similarity threshold 622 and the retrieval threshold 624 may be used to define operational conditions used in generation of the retrieval pairs 424 during the retrieval stage 412. As such, the similarity threshold 622 may determine a threshold for the hallucination detection tool 306 to pair references with predictions when generating the retrieval pairs 424. The retrieval threshold 624 may determine a number of reference segments (e.g., sentences) to include in the retrieval pairs 424. The retrieval stage 412 may rank the reference segments 422 and provide the number of reference segments based on input to the retrieval threshold 624.

At block 684 of the process 680, the hallucination detection tool 306 may display the prediction 402 and one or more associated reference segments 626 via the GUI 600.

The prediction 402 may be based on a query to the LLM. For example, as shown the prediction 402 may include a summary 628 of one or more references 406 displayed in the highlight field 610. In some embodiments, each prediction segment 420 of the summary 628 may be identified and linked to the associated reference segments 626 used to generate each prediction segment 420. For example, a first prediction segment 630, a second prediction segment 632, and a third prediction segment 634 may be displayed via the GUI 600. The associated reference segments 626 may be displayed for each prediction segment in the reference field 614. In certain embodiments, input by the user of a particular prediction segment may generate a popup window corresponding to the reference field 614 providing context of the associated reference segments 626 corresponding to the particular prediction segment.

At block 688 of the process 680, the hallucination detection tool 306 may display one or more citations 635 corresponding to the associated reference segments 636 within the references 406 used to generate the prediction 402. The citations 635 may include the associated reference segments 636 displayed within the references 406 from which the reference segments 422 were generated. Providing the citations 635 may provide contextualization of the associated reference segments 626 within the references 406 in which they were generated. The citations 635 may enable direct evaluation of the reference segments 626 used to generate each prediction segment 632, whereas previously, in an absence of generation of the reference segments 422 an entirety of the references 406 used to generate an LLM prediction were provided as citations associated with the LLM prediction. In some embodiments, the GUI 600 may allow a user of the hallucination detection tool 306 to determine if the prediction 402 of the LLM includes hallucinations. For example, the score field 608 may indicate to the user that the compiled hallucination score 434 of the summary 628 may be above a threshold hallucination score (e.g., 0.5, 50%). As such, the user may determine the faithfulness of the summary 628 based on comparison of the prediction segments 420, the reference segments 422, the associated reference segments 626 within the context of the reference 406, or a combination thereof.

The present disclosure is directed to a hallucination detection tool 306 to streamline hallucination detection for LLMs of an enterprise. In this manner, the hallucination detection tool 306 may identify hallucinations related to overtraining, contradiction within references used for training, vagueness of prompts, knowledge boundaries (e.g., lack of training in a specific area), and the like and provide prediction analytics based on hallucinations scores. The hallucination detection tool 306 may also provide a compiled hallucination score 434 indicative of faithfulness of the LLM. Additionally, present embodiments include creation of GUIs designed to provide near real-time insight into live hallucination detection and/or display hallucination detection reports within the platform of the enterprise. In this manner, the hallucination detection tool 306 provides streamlined access to hallucination detection. Integration of the hallucination detection tool 306 on the platform of the enterprise allows streamlined hallucination detection during development, deployment, and/or maintenance of various LLM based products (e.g., chatbots, summary generators, and the like). Previously, hallucination detection methods were implemented using an additional LLM to directly determine if each prediction of the LLM is truthful and/or faithful based on an entirety of references used to generate each prediction. Using the additional LLM to directly evaluate predictions of an LLM without generation of retrieval pairs is costly and resource intensive, resulting in an inefficient use of computing resources. By streamlining hallucination detection through incorporation of the hallucination detection tool 306, overall performance in determining hallucination of each prediction generated may decrease performance problems (e.g., latency, interpretability) to detect hallucinations, improving end user experiences of LLM based services offered by the enterprise.

Technical effects of the disclosed techniques include use of a hallucination detection tool 306 to provide hallucination detection to various LLM based products of an enterprise. The hallucination detection tool 306 may include various stages such as a prediction segmentation stage 408, a reference segmentation stage 410, a retriever stage 412, a hallucination detection stage 414, a scoring stage 416, and an aggregation stage 418. stage. The hallucination detection tool 306 may result in reduced computational costs associated with LLM implementation across an enterprise. Further, deployment of the presently disclosed techniques may provide improved efficiency and performance of implementing hallucination detection within LLMs within various software architectures of the enterprise.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving, from a large language model, a prediction that is based on a reference;
determining a plurality of prediction segments based on the reference and the prediction;
generating a retrieval pair associated with a first prediction segment of the plurality of prediction segments; and
generating a hallucination score for the retrieval pair associated with the first prediction segment, wherein the hallucination score indicates a likelihood that the first prediction segment includes a hallucination.

2. The method of claim 1, comprising:
segmenting the reference into a plurality of reference segments; and
segmenting the prediction into the plurality of prediction segments.

3. The method of claim 2, wherein the retrieval pair includes the first prediction segment of the one or more prediction segments and at least one reference segment of the plurality of reference segments that is associated with the respective prediction segment.

4. The method of claim 2, wherein each of the plurality of reference segments comprises a portion of the reference.

5. The method of claim 4, wherein each portion of the reference comprises a sentence.

6. The method of claim 2, comprising:
receiving the retrieval pair at one or more additional large language models; and
determining a semantic entailment between the first prediction segment of the plurality of prediction segments and at least one reference segment of the plurality of reference segments associated with the first prediction segment of the plurality of prediction segments.

7. The method of claim 1, comprising:
compiling the hallucination score for the retrieval pair and one or more additional retrieval pairs; and
outputting the compiled hallucination score for the prediction generated by the large language model, wherein the compiled hallucination score comprises a mean of each hallucination score for the retrieval pair and each of the one or more additional retrieval pairs.

8. The method of claim 1, wherein the hallucination score comprises a probability of hallucination based on the retrieval pair.

9. The method of claim 1, wherein the hallucination score is based on an alignment score, a word-based overlap, or any combination thereof.

10. The method of claim 1, wherein each of the one or more prediction segments comprises a sentence.

11. A system, comprising:
processing circuitry; and
memory, accessible by the processing circuitry, the memory storing instructions that, when executed by the processing circuitry, cause the processing circuitry to perform operations comprising:
receiving, from a large language model, a prediction that is based on a reference;
determining a plurality of prediction segments based on the reference and the prediction;
generating a retrieval pair for at least a subset of a plurality of prediction segments; and
generating a hallucination score for the retrieval pair associated with the subset of the plurality of prediction segments, wherein the hallucination score indicates a likelihood that the subset of the plurality of prediction segments includes a hallucination.

12. The system of claim 11, wherein the processing circuitry performs operations comprising:
segmenting the reference into a plurality of reference segments; and
segmenting the prediction into the plurality of prediction segments.

13. The system of claim 12, wherein the retrieval pair includes a first prediction segment of the plurality of prediction segments and at least one of the reference segments of the plurality of reference segments that is associated with the first prediction segment.

14. The system of claim 12, wherein the processing circuitry performs operations comprising:
receiving the retrieval pair at one or more additional large language models; and
determining a semantic entailment between the subset of the plurality of prediction segments and at least one of reference segment of the plurality of reference segments associated with the first prediction segment of the plurality of prediction segments.

15. The system of claim 11, wherein the processing circuitry performs operations comprising:
compiling the hallucination score for the retrieval pair and one or more additional retrieval pairs, wherein the hallucination score comprises a probability of hallucination based on the retrieval pair; and
outputting the compiled hallucination score for the prediction generated by the large language model.

16. The system of claim 15, wherein each of the plurality of prediction segments comprises a sentence.

17. A non-transitory computer-readable storage medium, comprising processor-executable routines that, when executed by a processor, cause the processor to perform operations comprising:
receiving, from a large language model, a prediction that is based on a reference;
determining a plurality of prediction segments based on the reference and the prediction;
generating a retrieval pair associated with a first prediction segment of the plurality of prediction segments; and
generating a hallucination score for the retrieval pair associated with the first prediction segment of the plurality of prediction segments, wherein the hallucination score indicates a likelihood that the first prediction segment includes a hallucination.

18. The non-transitory computer-readable storage medium of claim 17, wherein the processor performs operations comprising:
compiling the hallucination score for the retrieval pair and one or more additional retrieval pairs; and
outputting the compiled hallucination score for the prediction generated by the large language model, wherein the compiled hallucination score comprises a mean of each hallucination score of the retrieval pair and each of the one or more additional retrieval pairs.

19. The non-transitory computer-readable storage medium of claim 17, wherein the processor performs operations comprising:
segmenting the reference into a plurality of reference segments; and
segmenting the prediction into the plurality of prediction segments.

20. The non-transitory computer-readable storage medium of claim 19, wherein the processor performs operations comprising:
receiving the retrieval pair at one or more additional large language models; and
determining a semantic entailment between the first prediction segment of the plurality of prediction segments and at least one reference segment of the plurality of reference segments associated with the respective prediction segment.
